(19) United States
(12) Patent Application Publication
(10) Pub. No.: US 2013/0254682 A1
(43) Pub. Date: Sep. 26, 2013

(54) PROXYING AN ACTIVE LINK FROM A SHARED COMPUTER

(71) Applicants: Lisa Seacat DeLuca, San Francisco, CA (US); Soobaek Jang, Hamden, CT (US); Daniel C. Krook, Fairfield, CT (US)

(72) Inventors: Lisa Seacat DeLuca, San Francisco, CA (US); Soobaek Jang, Hamden, CT (US); Daniel C. Krook, Fairfield, CT (US)

(73) Assignee: International Business Machines Corporation, Armonk, NY (US)

(21) Appl. No.: 13/560,615

(22) Filed: Jul. 27, 2012

Related U.S. Application Data
(63) Continuation of application No. 13/429,896, filed on Mar. 26, 2012.

(51) Int. Cl. G06F 3/01; G06F 15/16

(52) U.S. Cl. 715/753

(57) ABSTRACT

Proxying an active link during a collaborative networking session includes analyzing content on a computer screen of a presenter of the collaborative networking session, and identifying the active link in the content. The active link corresponds to an image of the active link for presentation on a computer screen of a computer of a participant of the session. Proxying the active link also includes calculating a relative position of the active link with regard to the computer screen of the presenter using a two-dimensional coordinate system mapping process, creating a reproduction of the active link from the image, and placing the reproduction at a corresponding relative position on the computer screen of the participant. The reproduced active link on the computer screen of the participant is active and selectable during the session.

### CROSS-REFERENCE TO RELATED APPLICATION

This application is a continuation of U.S. patent application Ser. No. 13/429,896, filed Mar. 26, 2012, the disclosure of which is incorporated by reference herein in its entirety.

### BACKGROUND

The present invention relates to collaborative applications and, more specifically, to proxying an active link from a shared computer during a collaborative session.

As global collaboration becomes more and more natural to people, more virtual meetings are taking place. People often find themselves watching and listening on a webcast or web conference where a presenter shares their screen for presentation or demo, and others view the shared screen on their own computers. However, during screen sharing, when an active link such as an email or hyperlink appears on the presenter's screen and is shared to end users, if the link is of interest to the end users, they must write down the link information manually, as the links displayed on the participating user's computer screens are not active or selectable.

### SUMMARY

According to one embodiment of the present invention, a method for collaborative networking is provided. The method includes analyzing, via a computer processor, content on a computer screen of a presenter of a collaborative networking session, and identifying an active link in the content from the analyzing. The active link corresponds to an image of the active link for presentation on a computer screen of a computer of a participant of the collaborative networking session. The content of the computer screen of the presenter is shared with the participant. The method also includes calculating a relative position of the active link with regard to the computer screen of the presenter using a two-dimensional coordinate system mapping process, creating, via the computer processor, a reproduction of the active link from the image, and placing the reproduction at a corresponding relative position on the computer screen of the participant. The reproduction on the computer screen of the participant is active and selectable during the collaborative networking session.

According to a further embodiment of the present invention, a computer program product for collaborative networking is provided. The computer program product includes a storage medium having computer-readable program code embodied thereon, which when executed by a computer processor, causes the computer processor to implement a method. The method includes analyzing content on a computer screen of a presenter of a collaborative networking session, and identifying an active link in the content from the analyzing. The active link corresponds to an image of the active link for presentation on a computer screen of a computer of a participant of the collaborative networking session. The content of the computer screen of the presenter is shared with the participant. The method also includes calculating a relative position of the active link with regard to the computer screen of the presenter using a two-dimensional coordinate system mapping process, creating a reproduction of the active link from the image, and placing the reproduction at a corresponding relative position on the computer screen of the participant. The reproduction on the computer screen of the participant is active and selectable during the collaborative networking session.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts a block diagram of a system upon which collaborative networking may be implemented according to an embodiment of the present invention;

FIG. 5 depicts a flow diagram of a process for providing collaborative networking according to an embodiment of the present invention;

FIG. 6 depicts a computer screen window with sample data as seen by a collaborative session presenter according to an embodiment of the present invention; and

FIG. 7 depicts a computer screen window with sample data as seen by a collaborative session participant according to an embodiment of the present invention.

### DETAILED DESCRIPTION

Exemplary embodiments relate to collaborative networking, which provide the ability to proxy an active link associated with a shared computer to another computer, whereby both the shared computer and the other computer are participating in a collaborative session in a network environment. In one exemplary embodiment, the network environment operates via a cloud infrastructure in which the storage of, and access to, data is managed by a service provider on behalf of a service provider and/or end user.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed (e.g., any client-server model).

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

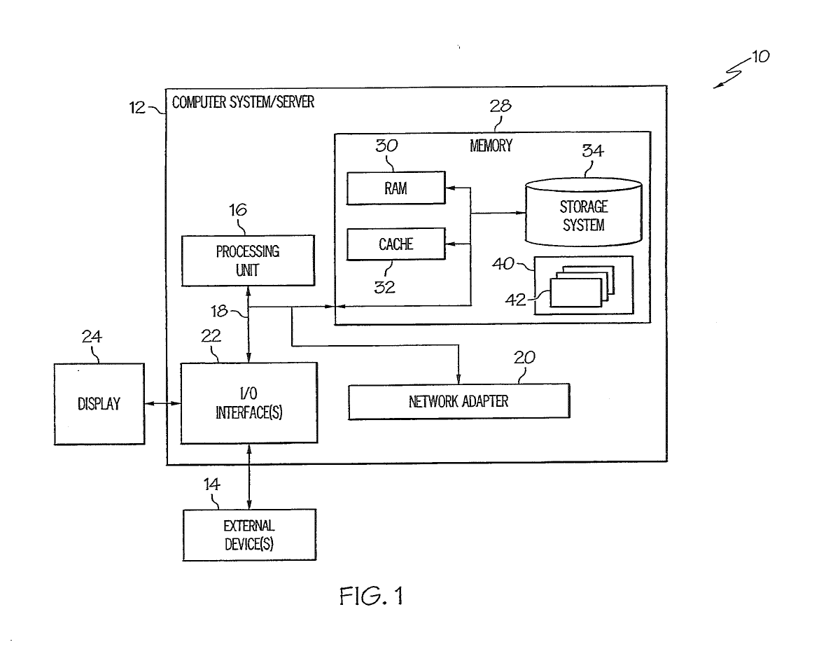

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

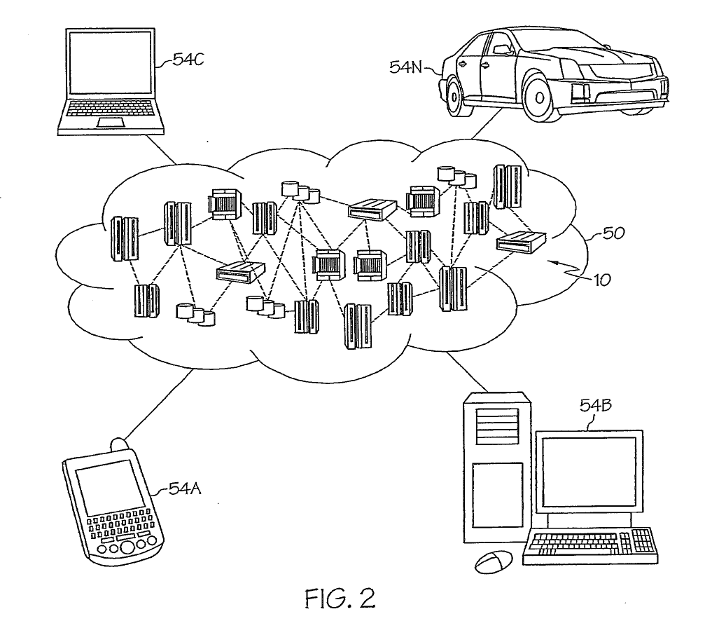

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

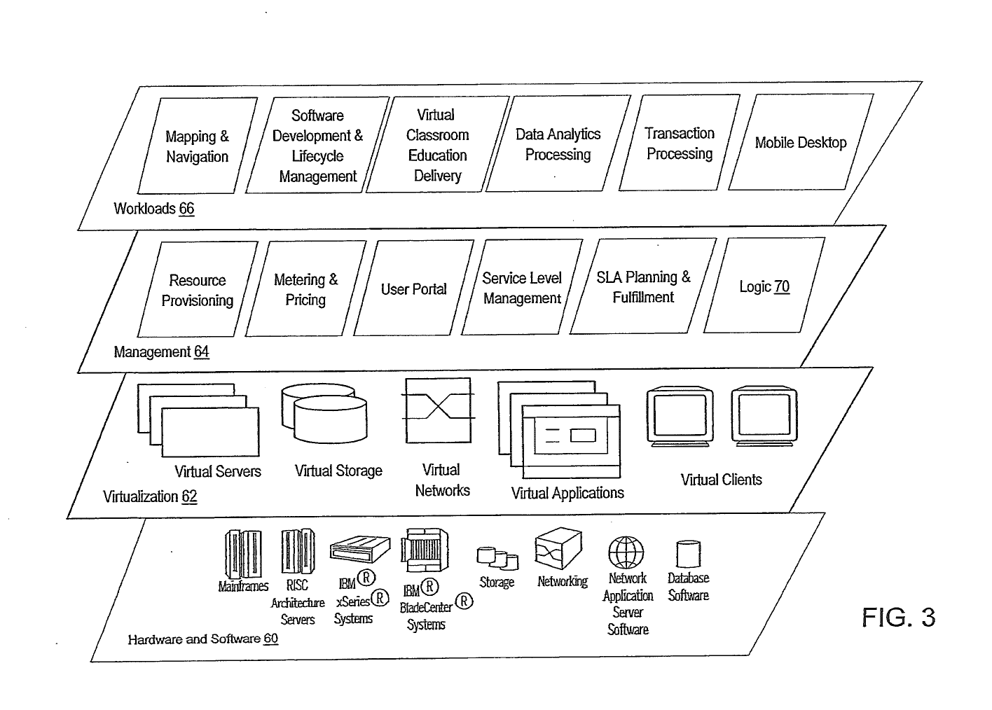

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide)

Virtualization layer 62 provides an abstraction layer from which the following examples of virtual entities may be provided: virtual servers; virtual storage; virtual networks, including virtual private networks; virtual applications and operating systems; and virtual clients.

In one embodiment, one or both of the hardware and software layer 60 and the virtualization layer 62 may include edge components, such as a web server front end and image cache, as well as an image library store, e.g., in a high-performance RAID storage area network (SAN).

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security (not shown) provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. In one exemplary embodiment, logic 70 in the management layer 64 implements the exemplary collaborative networking processes described herein; however, it will be understood that the logic 70 may be implemented in any layer.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a mobile desktop for mobile devices (e.g., 54A, 54C, and 54N, as well as mobile nodes 10 in cloud computing environment 50) accessing the cloud computing services.

The logic 70 includes one or more algorithms to implement embodiments described herein to provide collaborative networking services. In an embodiment, the logic 70 is coupled to and/or resides in the memory 28 shown in FIG. 1. In addition, embodiments of the logic 70 include one or more program modules 42 of the program/utility 40 shown in FIG. 1. In a further embodiment, the logic 70 is part of the management layer 64 and is executed on hardware located in the hardware and software layer 60.

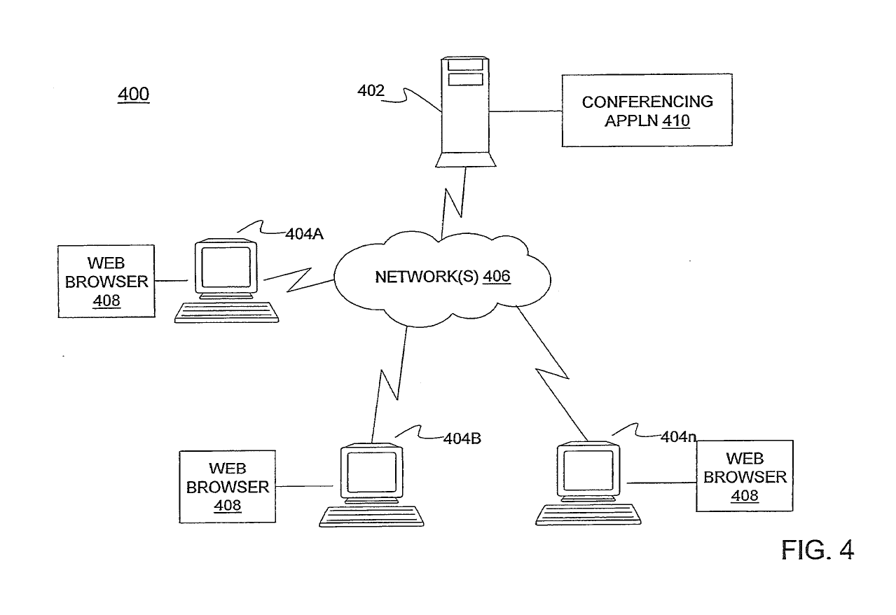

The exemplary collaborative networking services may be implemented by a computer device (e.g., computer system 12) to share content from collaborative applications to other computer devices. The collaborative applications may include web conferencing software, webcast software, virtual meeting tools, or other collaborative systems. The collaborative applications enable a presenter to share his/her computer screen, as well as audio, with other computers over a network. These and other aspects of the collaborative networking services will now be described with respect to FIGS. 4-7.

Turning now to FIG. 4, a system upon which the collaborative networking services may be implemented will now be described. The system 400 of FIG. 4 depicts a host system computer 402 and user systems 404A-404n in communication with one or more networks 406. The networks 406 may include a cloud computing network (e.g., the network 50 of FIG. 2) that offers virtual computing services to end users.

The host system computer 402 may be implemented as one or more high-speed computer processing devices, such as one or more mainframe computers capable of handling a high volume of computing activities conducted by end users of the cloud computing network. The host system computer 402 executes logic (e.g., conferencing application) 410 for implementing the collaborative networking. The logic 410 refers to the logic 70 described above in FIG. 3.

As shown in FIG. 4, user systems 404A-404n are provided. For illustrative purposes, user system 404A refers to a presenter of a collaborative networking session, and user systems 404B-404n represent participants of the collaborative networking session. For purposes of illustration, the collaborative networking session is a web conference. Each of the user systems 404A-404n includes a web browser application 408 executable thereon, and the respective participants may access the web conferencing session via the host system computer 402 over the networks 406. In an alternative embodiment, the web conferencing application 410 may reside on a user system, such as the presenter's user system 404A.

Each of the user systems 404A-404n may be any type of computer device, such as a general-purpose desktop, or may be a portable communication device, such as a laptop or portable hand held computer device (e.g., a smart phone). The user systems 404A-404n may correspond to the cloud computing node 10 of FIG. 1 or the cloud consumers 54A-54N shown in FIG. 2.

As described above, the exemplary collaborative networking processes provide the ability to proxy an active link on a presenter's computer to a participant's computer. An active link refers to a character string, icon, symbol, or graphic, which upon selection or “clicking on,” redirects a user to a web page, document, or other source of content. Currently, an active link on a presenter's computer screen will be replicated to the participant's computer screen, but the link will be simply an image of the active link only. In other words, the image of the active link presented on the participant's computer screen is not active in that it cannot be selected for accessing a corresponding web page or other content. The exemplary collaborative networking services provide the ability to proxy the active link to the participating computers.

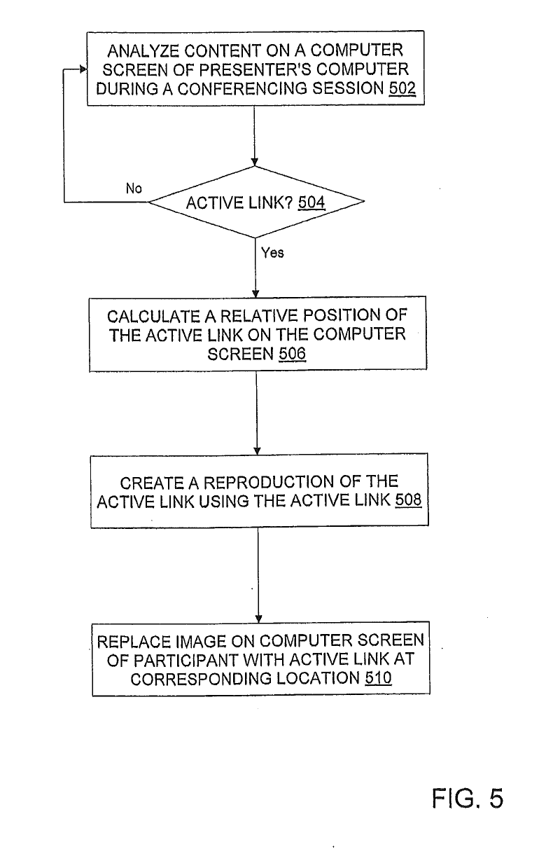

Turning now to FIG. 5, a process for implementing the collaborative networking services will now be described in an exemplary embodiment. The processes described in FIG. 5 assume that a web conferencing session has been initiated by a presenter at user system 404A whereby participants of the web conferencing session have accessed the conferencing application 410, and a computer screen of content associated with the session is rendered on the presenter's user system 404A.

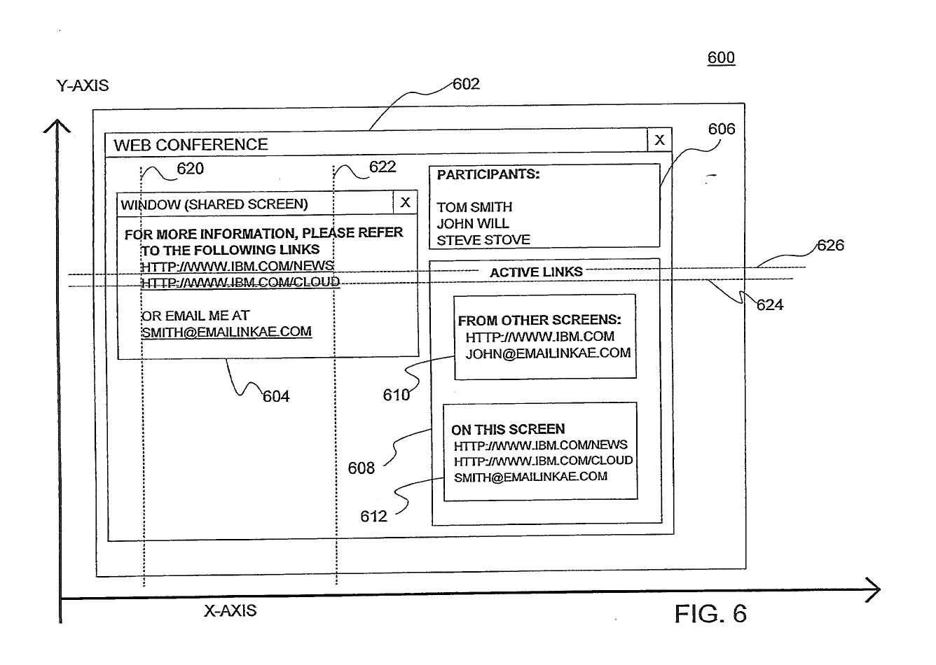

At step 502, the logic 410 analyzes the content of the computer screen on the presenter's user system 404A. The analysis includes searching the content for characters and symbols indicative one or more of an email address, web page, and uniform resource locator in order to identify an active link. For example, the logic 410 may be configured to search for character strings that include “HTTP,” “.com,” “.org,” or other indicators of a link, as well as the symbol “@” to identify an email address. As shown in FIG. 6, for example, a computer screen 600 includes a web conference screen 604 that includes active links to two web pages, as well as an email address. The web conference screen 604 represents the web content of a conferencing session as seen by a presenter of the session. The computer screen 600 also includes a window 606 listing the participants of the web conferencing session, and a window 608 listing active links from the conferencing session.

At step 504, it is determined whether an active link on the computer screen of the presenter has been identified. If not, the process returns to step 502 whereby the logic 410 continues to analyze the content for an active link.

At step 506, if an active link has been identified, the logic 410 calculates a relative position of the active link on the presenter's computer screen. The relative position of the active link may be determined using a two-dimensional coordinate system mapping process. The two-dimensional coordinate system mapping process may include overlaying the content of the computer screen of the presenter with a two-dimensional coordinate system (e.g., an x and y axis), and mapping the active link to x and y coordinates on the two-dimensional coordinate system. As shown in FIG. 6, an x and y axis are overlaid onto the computer screen 600 and the coordinates of an active link “HTTP://WWW.IBM.COM/CLOUD” are calculated, as indicated by x-axis bounded, dotted lines 624 and 626, and y-axis bounded, dotted lines 620 and 622, respectively. Thus, the relative position of the active link is defined by the cross points of these dotted lines.

Using these coordinate values, the logic 410 creates a reproduction of the active link utilizing, e.g., HTML (e.g., <a href=www.ibm.com>ibm.com<a>) at step 508. The HTML is created to match the link and place it in the location where the link appears on the participant's computer screen (e.g., using hot spots or image maps) at step 510. The placement of the active link on the participant's screen may be accomplished at the time the image is displayed on the participant's screen or immediately thereafter, e.g., using screen scraping technologies, and the active link may be over overlaid onto the image on the participant's screen using the coordinate values. The reproduction of the active link is selectable by the participant via the web browser 408 implemented on the user system 404 of the participant during the web conference.

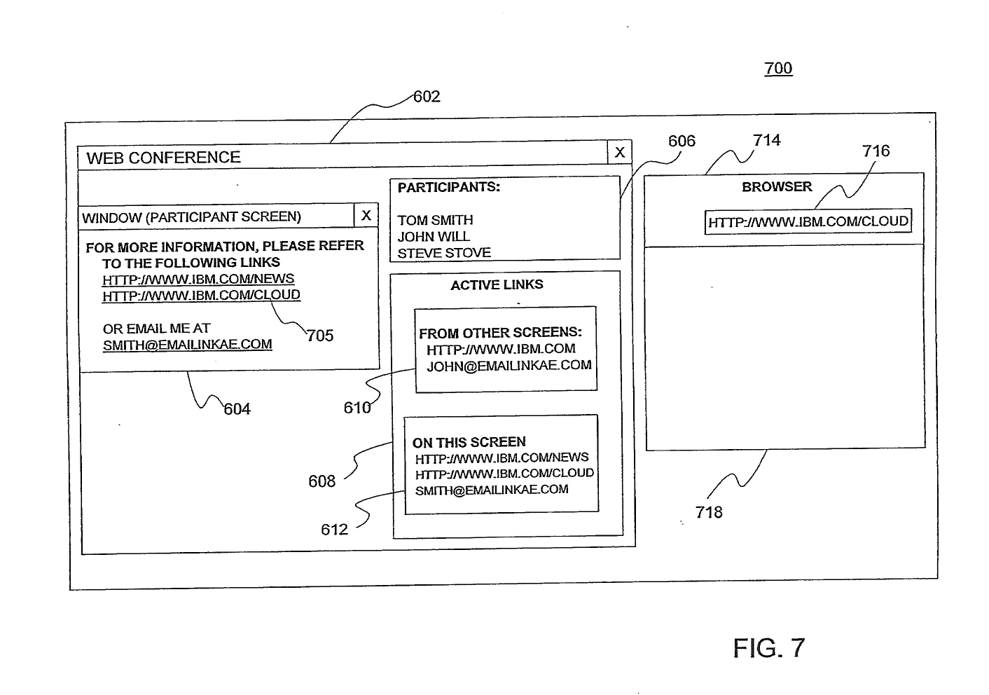

In an embodiment, the logic 410 may alternatively, or in addition to presenting the reproduced active link in the corresponding relative location, populate a different window of the computer screen with the reproduced active link. As shown in FIGS. 6 and 7, each of computer screens 600 and 700, as seen by a presenter and a participant, respectively, of the web conferencing session includes a window 612 of active links. The window 612 lists any other reproduced active links contained in the content of the computer screen of the presenter. Each of the reproduced links is active and selectable by the participant via the web browser 408 on the participant's user system 404B.

Additionally, as shown in FIGS. 6 and 7, the logic 410 may be configured to populate another window 610 with reproduced active links contained in other computer screens of the conferencing session. These may be links presented in content screens displayed earlier in the session (e.g., a running list of links presented to the current time), or may be total all of the links from the session.

In a further embodiment, the logic 410 may be configured to track the selection of these reproduced links (e.g., whenever a participant clicks on a reproduced link) and provide a reporting of this tracking (e.g., by participant or by the selected link) to the presenter or other interested individual (e.g., a participant may wish to know which links were accessed by other participants.

Technical effects include collaborative networking, which provide the ability to proxy an active link associated with a shared computer to another computer, whereby both the shared computer and the other computer are participating in a collaborative session in a network environment. The network environment operates via a cloud infrastructure in which the storage of, and access to, data is managed by a service provider on behalf of a service provider and/or end user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed:

1. A method, comprising:
analyzing, via a computer processor, content on a computer screen of a presenter of a collaborative networking session;
identifying an active link in the content from the analyzing, the active link corresponding to an image of the active link for presentation on a computer screen of a computer of a participant of the collaborative networking session, wherein the content of the computer screen of the presenter is shared with the participant;
calculating a relative position of the active link with regard to the computer screen of the presenter using a two-dimensional coordinate system mapping process;
creating, via the computer processor, a reproduction of the active link from the image; and
placing the reproduction at a corresponding relative position on the computer screen of the participant, the reproduction on the computer screen of the participant being active and selectable during the collaborative networking session.

2. The method of claim 1, wherein the analyzing content includes searching the content for characters and symbols indicative of at least one of an email address, domain, and uniform resource locator.

3. The method of claim 1, wherein the two-dimensional coordinate system mapping process includes overlaying the content of the computer screen of the presenter with a two-dimensional coordinate system, and mapping the active link to x and y coordinates on the two-dimensional coordinate system.

4. The method of claim 1, wherein placing the reproduction at a corresponding relative position on the computer screen of the participant includes overlaying the reproduction at the corresponding relative position of the image.

5. The method of claim 1, further comprising:
saving any other reproduced active links contained in the content of the computer screen of the presenter, and presenting the reproduction of the active link in a separate window on the computer screen of the participant, the separate window listing the any other reproduced active links contained in the content of the computer screen of the presenter, the reproduction of the active link and the any other reproduced active links in the separate window being active and selectable by the participant via the web browser implemented on the computer of the participant during the collaborative networking session.

6. The method of claim 1, further comprising:
saving reproductions of active links contained in other computer screens of the presenter; and presenting the reproductions of the active links in a separate window on the computer screen of the participant during the collaborative networking session.

7. The method of claim 1, further comprising:
tracking, by the computer processor, selection of the reproduction of the active link by the participant; and
presenting an indication of the selection to the presenter.

8. A computer program product comprising a storage medium having computer-readable program code embodied thereon, which when executed by a computer processor, causes the computer processor to implement a method, the method comprising:
analyzing content on a computer screen of a presenter of a collaborative networking session;
identifying an active link in the content from the analyzing, the active link corresponding to an image of the active link for presentation on a computer screen of a computer of a participant of the collaborative networking session, wherein the content of the computer screen of the presenter is shared with the participant;
calculating a relative position of the active link with regard to the computer screen of the presenter using a two-dimensional coordinate system mapping process;
creating a reproduction of the active link; and
placing the reproduction at a corresponding relative position on the computer screen of the participant, the reproduction on the computer screen of the participant being active and selectable during the collaborative networking session.

9. The computer program product of claim 8, wherein the analyzing content includes searching the content for characters and symbols indicative of at least one of an email address, domain, and uniform resource locator.

10. The computer program product of claim 8, wherein the two-dimensional coordinate system mapping process includes overlaying the content of the computer screen of the presenter with a two-dimensional coordinate system, and mapping the active link to x and y coordinates on the two-dimensional coordinate system.

11. The computer program product of claim 8, wherein placing the reproduction at a corresponding relative position on the computer screen of the participant includes overlaying the reproduction at the corresponding relative position of the image.

12. The computer program product of claim 8, wherein the method further comprises:
presenting the reproduction of the active link in a separate window on the computer screen of the participant, the separate window listing any other reproduced active links contained in the content of the computer screen of the presenter, the reproduction of the active link in the separate window being active and selectable by the participant via the web browser implemented on the computer of the participant during the collaborative networking session.

13. The computer program product of claim 8, wherein the method further comprises:
presenting reproductions of active links contained in other computer screens of the presenter in a separate window on the computer screen of the participant, the separate window listing any other reproduced active links contained in the other computer screens of the presenter.

14. The computer program product of claim 8, wherein the method further comprises:
tracking selection of the reproduction of the active link by the participant; and
presenting an indication of the selection to the presenter.
